(19) United States
(12) Patent Application Publication
(10) Pub. No.: US 2014/0008208 A1
(43) Pub. Date: Jan. 9, 2014

(54) THERMAL SYSTEM AND PROCESS FOR PRODUCING STEAM FROM OILFIELD PRODUCED WATER

(71) Applicant: Garry Pichach, Calgary (CA)

(72) Inventor: Garry Pichach, Calgary (CA)

(21) Appl. No.: 13/541,813

(22) Filed: Jul. 5, 2012

(51) Int. Cl. C02F 1/04; B01D 3/42; C02F 101/32; C02F 101/10

(52) U.S. Cl. 203/1; 210/737

(57) ABSTRACT

A continuous thermal process for treating oilfield produced water and generating steam from the same is provided. Raw water in is passed in direct counterflow heat exchange with produced steam to heat the raw water to a temperature at which a substantial portion of dissolved calcium and magnesium ions in the raw water are precipitated as insoluble salts. The raw water is further passed into a reaction zone for completion of reactions. A strong base is added to the raw water prior to passing the raw water in direct counterflow heat exchange with the produced steam in amount such that pH of the reaction zone is at least 10.5 as measured by a pH sensor to promote silica soluability. Other embodiments are also disclosed.

### FIELD OF THE INVENTION

The present invention relates generally to systems and processes for producing steam, and more particularly, but not by way of limitation, to systems and processes for treating low quality oilfield produced water and producing high quality steam from the same.

### BACKGROUND OF THE INVENTION

Several enhanced oil recovery methods for producing formation fluids from a subterranean formation include the injection of steam into the formation to stimulate production. Steam assisted gravity drainage (SAGD) is an example of a predominately used enhanced oil recovery method utilizing steam injection.

Steam injection, such as in SAGD, requires a source of high quality feedwater that is substantially free of excessive amounts of scale forming and corrosive elements to prevent to boiler scaling and fouling. Generally feedwater is considered to be of acceptable quality for boiler operation when the water has a total hardness of less than 0.5 mg/L as CaCO3, has as less than 50 mg/L of silica, has less than 10,000 mg/L of total dissolved solids, and has less than 10 mg/L of oil. A source of quality feedwater at most oilfields is not available, and thus it is desirable to recycle water that is produced from the formation to generate steam for reinjection into the formation. Oilfield produced water is considered low quality and is not suitable for steam production without extensive pretreatment.

Various methods and systems have been developed for the purpose treating produced water to render it suitable for steam production. Several of the prior systems and methods are described in U.S. Pat. No. 4,398,603. One system and method of particular interest is disclosed in U.S. Pat. No. 3,410,796 to Hull, the entirety of which is incorporated herein by reference. The Hull patent entitled “Process for Treatment of Saline Waters” discloses a thermosludge water treating and steam generation process which embodiments of the present invention provide improvements upon.

A drawback to the Hull thermosludge system is the use of a series of baffles in a stripper column over which feedwater is forced to flow while in direct counterflow heat exchange with steam. The purpose of the baffles in the stripper column is to cause precipitation of carbon dioxide from the feedwater to increase feedwater pH to an ideal pH for ion precipitation of insoluble salts in a reaction zone containing a quantity of heated feedwater while keeping silica in solution. The Hull thermosludge stripper is problematic for two reasons. First, the baffles would quickly become scaled and need to be cleaned requiring shutting down the system. Second, there was uncertainty to whether sufficient carbon dioxide precipitation occurred to raise and maintain the pH of the feedwater to the pH necessary to prevent silica deposition.

A second drawback to the Hull thermosludge system is the use of a thermosyphon reboiler for the purpose of converting feedwater into produced steam. The low feed water flow velocity in the tubes of thermosyphon reboiler made the reboiler prone to plugging from a build-up of sludge (precipitated insoluble salts).

A third drawback, albeit, less problematic than the above drawbacks is the use of an atmospheric tank at the beginning of the process to preheat the feedwater by flash steam and to separate oil and heavy solids (sand, etc.) prior to entrance to the stripper. Depressurizing the feedwater, flashing steam, water condensing and repressurization of the feedwater is not energy efficient.

Notwithstanding the advantages of the Hull thermosludge process of treating produced feedwater with the generation of steam, the drawbacks resulted in minimal utilization in favor of separate feedwater pretreatment facilities and steam generation facilities. However, a desire remains for a single system and process for the treatment of produced feedwater and generation of steam to reduce the costs of operating separate pretreatment and steam generation systems.

### SUMMARY OF THE INVENTION

Embodiments of the present invention addresses this need by providing a thermal system and process for producing steam from oilfield produced water that concurrently treats feedwater and produces steam that eliminates the drawbacks of the prior art.

To achieve these and other advantages, in general, in one aspect, in continuous thermal process for treatment of raw water including passing the raw water in direct counterflow heat exchange with produced steam to heat the raw water to a temperature at which a substantial portion of dissolved calcium and magnesium ions in the raw water are precipitated as insoluble salts and passing the raw water into a reaction zone for completion of reactions, an improvement comprises adding a strong base to the raw water prior to passing the raw water in direct counterflow heat exchange with the produced steam in amount such that pH of the reaction zone is at least 10.5 as measured by a pH sensor.

In general, in another aspect, a reboiler including forced fluid recirculation through a heat exchanger, such as, for example shell and tube or the like is used to produce steam from feedwater. In aspects, the heat exchanger is fitted with an automatic and/or on-line cleaning system used to continually clean the heat exchanger.

In general, in another aspect, a free water knock out separates oil and gas from produced raw feedwater to generate a feedwater stream. Aspects further include blow-down sludge separation to recover water for recycling as make-up, and further oil recovery.

In general, in another aspect, a continuous thermal process for treating oilfield produced water and generating steam from the same is provided and includes the steps of: (a) passing raw produced water through a free water knock out thereby forming a feed water; (b) adding a pH buffer to the feed water; (c) introducing the feed water into a contact vessel after buffering; (d) passing the feed water in direct counter flow heat exchange with a produced steam within the contact vessel to heat the feed water to a temperature at which a substantial portion of dissolved calcium and magnesium ions in the raw water are precipitated as insoluble salts while silica remains in solution; (e) passing the feed water into a reaction zone for completion of reactions; (f) measuring the pH of the feed water in the reaction zone; and (g) controlling the amount of pH buffer added in step (b) so as to maintain a pH of at least 10.5 is the reaction zone.

In general, in another aspect, a contact vessel includes a horizontally disposed settling tank having a series of vertically extending interior baffles that horizontally divided the interior into a clean water compartment and a dirty water compartment. A stripping column is connected to the settling vessel and extends vertically upward therefrom and is fluidically connected with the dirty water compartment. A sludge boot is connected to the settling vessel and extends vertically downward therefrom and is in fluidically connected with the dirty water compartment. A steam outlet is located at the top of the stripping column in fluidic communication with the interior of the stripping column. A feed water inlet is located at the top of the stripping column at a position vertically bellow the steam outlet and in fluidic communication with the interior of the stripping column. A water and steam return inlet is located at the bottom of the stripping column and in fluidic communication with the interior of the stripping column. A clean water outlet is in fluidic communication with the clean water compartment of the settling tank, and a sludge blow-down is in fluidic communication with the interior of the sludge boot.

In general, in another aspect, a contact vessel includes first and second vertical vessels fluidically connected together at an intermediate location between their opposed ends. A steam outlet located at the top of the first vertical vessel and in fluidic communication with the interior thereof. A feed water inlet is located at the top of the first vertical vessel at a position vertically bellow the steam outlet and in fluidic communication with the interior of the first vertical vessel. A water and steam return inlet is located at the bottom of the first vertical vessel and in fluidic communication with the interior thereof. A sludge blow-down is located at the bottom of the first vertical vessel and in fluidic communication with the interior thereof. A clean water outlet is located at the bottom of the second vertical vessel and in fluidic communication with the interior thereof, and a second steam is located outlet at the top of the second vertical vessel and in fluidic communication with the interior thereof.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a schematic diagram of a thermal system and process for producing steam from oilfield produced water constructed in accordance with the principles of an embodiment the present invention;

FIG. 2 is a schematic diagram of a contact vessel constructed in accordance with the principles of an embodiment the present invention; and

FIG. 3 is a schematic diagram of a contact vessel constructed in accordance with the principles of an embodiment the present invention.

### DETAILED DESCRIPTION OF THE INVENTION

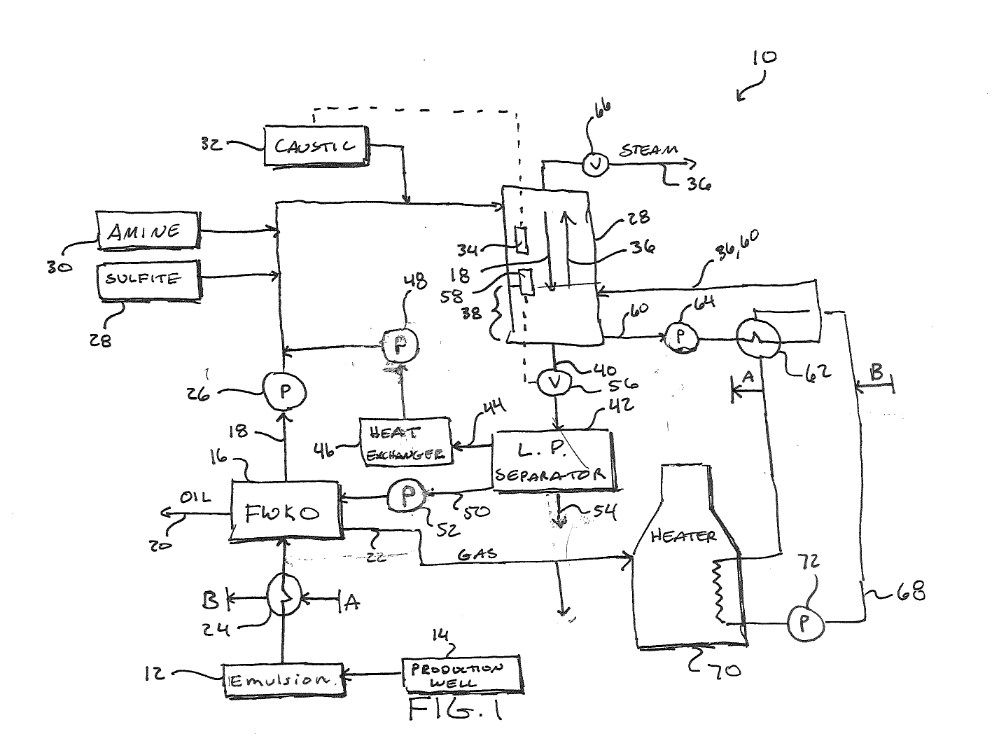

With reference to FIG. 1, a thermal system and process for treating saline or brackish water for generating steam representatively embodying principles of the present invention is designated generally by the reference number 10. While the thermal system and process 10 is illustrated and described herein in connection with the treatment and production of steam from oilfield produced water for the purpose of oil field steam injection, it will be readily apparent the present system and process is not limited to this specific application and may be utilized to produce softened or descaled water for other uses.

Untreated or raw water 12 recovered from an oil production well 14 is passed through a Free Water Knockout (FWKO) 16 which operates to separate the raw water into a feed water stream 18, an oil stream 20 and a gas stream 22. The raw water 12 entering the FWKO 16 may be water that has been separated and recovered from other produced formation fluids. Additionally, prior to passing through the FWKO 16, the raw water 12 may be heated by passing through heat exchanger 24 to raise the temperature of the raw water for the purpose of inverse oil-water separation of heavy oil without the need for diluent addition.

The feed water 18 from the FWKO 16 is pumped by pump 26 to the top of a steam drum or contact vessel 28. Prior to entering the contact vessel 28, sulfite from a sulfite storage tank 30 and an amine inhibitor from amine storage tank 32 may be added to feed water 18. Further to the sulfite and the amine inhibitor addition, a strong base, such as sodium hydroxide (NaHO), from a caustic storage tank 32 is added to the feed water 18 to raise the pH within the contact vessel 28 to at least a pH of 10.5, and preferably to at least a pH of 11.0. A pH sensor 34 measures the pH within the contact vessel 28 and the amount of caustic addition to the feed water 18 is controlled as a function of the measured pH to maintain the pH within the contact vessel at a pH of at least 10.5, and preferably at least 11.0 to ensure that the proper chemical reactions and salt precipitation from the feed water occurs within the contact vessel.

Caustic addition to the feed water 18 prior to the feed water entering the contact vessel 28 permits the elimination of the problematic stripper column of the devices heretofore that were relied upon for the purpose of precipitating carbon dioxide from the feed water to increase the pH within the contact vessel.

Feed water 18 enters at the top of the contact vessel 28 and flows downwardly therein in direct counterflow heat exchange with upwardly flowing produced steam 36, and then collects at the bottom of the contact vessel in a reaction zone 38. In the reaction zone 38, chemical reactions are completed and a majority of the insoluble salts are precipitated forming a watery sludge or blow-down. The chemical reactions that occur within the contact vessel 28 and reaction zone 38 are well known, and thus a complete description of these reactions is not required herein for an understanding of the embodiments of the present invention. A detailed description of the reactions is described in U.S. Pat. No. 3,410,796.

The watery sludge 40 is removed from the bottom of the contact vessel 28 through a blow-down outlet and is passed through a separator 42, such as, for example, a low pressure separator operating at atmospheric pressure. Separator 42 operates to separate blow-down sludge into a stream of flash steam 44, a stream of slop oil 50, and stream of sludge 54. The flash steam 44 is condensed in heat exchanger 46 and is recycled to feed water 18 as make-up water by pump 48. The slop oil 50 is recycled to the FWKO 16 by pump 52 to further recover water for addition to the process as make-up water, and the sludge 54 is disposed of.

The flow of blow-down sludge 40 to the separator 42 is controlled by valve 56, which is operated to maintain a desired water level within the contact vessel. A liquid level sensor 58 measures the level of water within the contact vessel 28, and the valve 56 is operated to open or close as a function of the measure water level to maintain the water the desired level.

Water 60 from the contact vessel 28 is circulated through a heat exchanger 62 by pump 64. In heat exchanger 62, the water 60 is heated and is partially converted to steam 36 forming a water and steam mixture 36,60 that is returned to the contact vessel at a position below the water level therein to facilitate heat exchanger between the heated water and steam mixture and the water in the contact vessel. Steam 36 then flows upwardly in direct heat exchange with feed water 18. A portion of the steam 36 is condensed and combines with the feed water. The balance of the steam 36, which is saturated during upward flow, leaves the top of the contact vessel 28 for further use, such as injection into a hydrocarbon formation. Valve 66 is operated to control the flow of steam 36 leaving the contact vessel 28 and to maintain a desired pressure within the contact vessel.

Heat exchanger 62 is an indirect heat exchanger, such as, for example a shell-and-tube or double-pipe type that is designed for on-line cleaning through the use of available on-line tube cleaning systems. An example of a heat exchanger automatic tube cleaning system is a ball injection system on the inlet and a ball trap on the exchanger outlet. The heat exchanger 62 may also be isolated from the contact vessel 28 to allow for off-line mechanical pigging or chemical cleaning

Although any suitable heated medium may be used as a heat exchange fluid in heat exchanger 62. High temperature heat transfer thermal oil is preferred. The oil 68 is circulated by pump 72 through a gas, coal or oil-fired heater 70 where the oil is heated and then through the heat exchanger 62 to heat the water 60 and form the water-steam mixture that is returned to the contact vessel 28. Within the heat exchanger 62, the water-steam temperature is typically in the range from 250 and 400 degrees Celsius. The process described above can be operated over pressure ranges from slightly above atmospheric pressure, as for example 5 PSIG, to as high as 800 PISG with corresponding steam temperature.

In embodiments, temperature in the contact vessel 28 is controlled by the quality of the steam from the forced recirculation heat exchanger 62 and the pressure of the contact vessel 28. In embodiments, the heat duty of the forced recirculation heat exchanger 62 or the speed of the forced recirculation pump 64 is adjusted as a function of the temperature measured within the contact vessel 28 by a temperature sensor. In further embodiments, the heat duty of the forced recirculation heat exchanger 62 or the speed of the forced recirculation pump 64 is adjusted as a function outlet steam flow rates as measured by a flow meter. In further embodiments, the temperature in the contact vessel 28 or steam quality are controlled by adjusting the thermal oil flow rate through the forced recirculation heat exchanger 62.

Additionally heat exchanger 24 may be connected to the circulation of the thermal oil 68 through line connections A and B to preheat the raw water 12 prior to passing through the FWKO 16.

Once precipitated in the reaction zone 38, the calcium and magnesium ions will not contribute to scaling within the forced recirculation exchanger 62. Silica is soluble at a pH of 11 and therefore also should not contribute to rapid scaling of the exchanger.

Oil contents of 100 ppm or more can be processed by system 10. The lighter oil fractions are stripped out and appear in the steam and the heavy fractions are adsorbed on or entrained by the sludge particles. The limited tube wall temperature keeps the hydrocarbons below the 650 to 700 F threshold where dehydrogenation reactions commence with consequent hard coke production. Hot spots, with their inevitable coke formation and buildup, just do not get started. The emulsifying action of the rather high pH environment on the heavy but not excessively carbonized materials undoubtedly also assists in preserving a clean system.

Deposits of sludge however are expected to build up within the forced recirculation heat exchanger 62. On-line tube cleaning systems are employed to continuously mechanically clean the exchanger in which high temperature balls capable of scouring the tube surface are released at the inlet, captured in a ball trap on the outlet and recycled through the exchanger. These systems are commercially available.

Eventually deposits of sludge, especially after a process upset, will require off-line cleaning of the heat exchanger 62. In this event the exchanger 62 is isolated and mechanically or chemically cleaned. On occasions the contact vessel 28 must also be mechanically or chemically cleaned requiring shutting down of the unit.

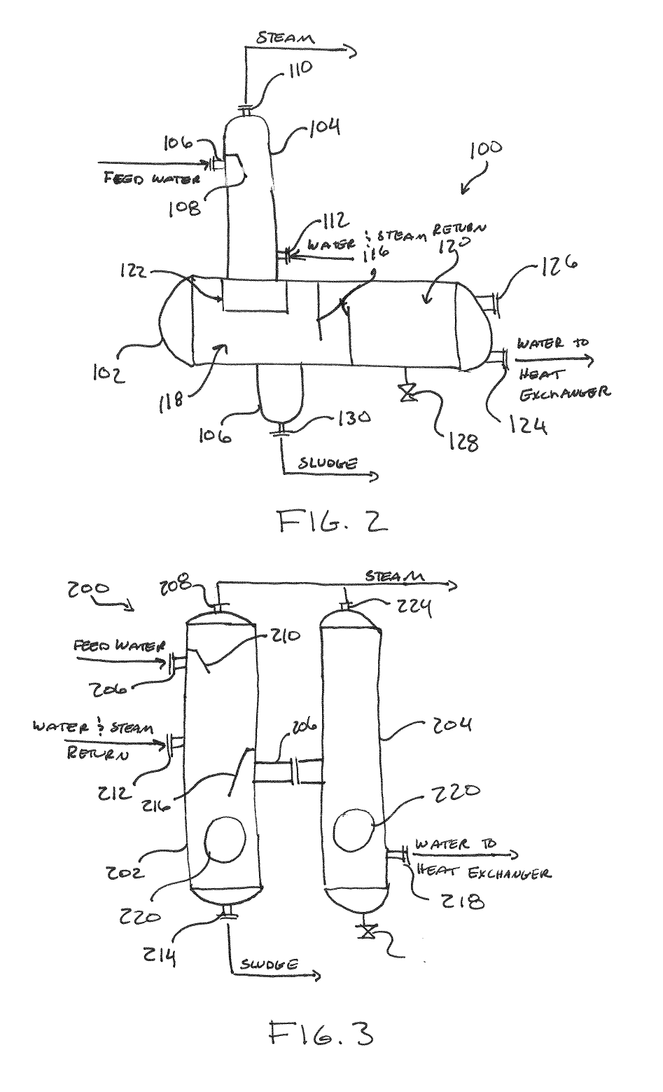

Turning now to FIG. 2, there is diagrammatically illustrated an embodiment of a contact vessel 100 constructed in accordance with the principals of the present invention suitable and that may be used as contact vessel 28 in the process and system described above. Contact vessel 100 includes horizontally disposed settling vessel 102, a stripping column 104 fluidically connected to a top side of the settling vessel and extending vertically upward therefrom, and a sludge collection boot 106 fluidically connected to a bottom side of the settling vessel and extending vertically downward therefrom.

Feed water enters the top of the stripping column 104 at fluid connection 106 and flows downwardly therein in direct counterflow heat exchange with upwardly flowing produced steam as discussed above. The produced steam exits the top of the stripping column 104 at fluid connection 110. An inlet diverter 108 may be provided on the interior of the stripping column 104 upon which feed water entering the stripping column may imping upon and as a result be downwardly directed. The hot water and steam mixture from the forced recirculation heat exchanger 62 enters at the bottom of the stripping column 104 at fluid connection 112.

A series of baffles 116 are vertically disposed within the settling vessel 102 and horizontally divide the settling vessel into a dirty water section 118 and a clean water section 120. Baffles 116 are configured to encourage the settling of sludge within the dirty water section 118 and prevent sludge migration into the clean water section 120. In embodiments, a downcomer 122 is encircles the fluid connection between the stripping column 104 and the settling vessel 102 and vertical extends downwardly into the settling vessel to further encourage solid/liquid separation in the settling vessel.

Water from the clean water section 120 is removed from the settling vessel 102 at fluid connection 124 for circulation through the forced circulation heat exchanger 62 as discussed above. The settling vessel 102 may further include one or more conventional manways 126 for inspecting and cleaning the settling vessel, and one or more conventional clean out ports 128, only one is illustrated for purpose of illustrative clarity, for collecting fluid samples from the settling vessel and for emptying the settling vessel. One of the clean out ports 128 may be fitted with pH sensor 34.

Sludge boot 106 is fluidically connected to the settling vessel 102 along the dirty water section 118. Sludge boot 106 provides a collection receptacle for sludge at the bottom side of the settling vessel 102 and further prevents sludge migration from the dirty water section 118 to the clean water section 120. Sludge collected in the sludge boot 106 is removed therefrom through fluid connection 130. The inclusion and operation of contact vessel 100 in system 10 is readily apparent from the above discussion.

Turning now to FIG. 3, there is diagrammatically illustrated another embodiment of a contact vessel 200 constructed in accordance with the principals of the present invention suitable and that may be used as contact vessel 28 in the process and system described above. Contact vessel 200 includes two vertically oriented, elongated and closed ended vessels 202 and 204. Vessels 202 and 204 are fluidically connected together at their side by fluid connection 206 at an intermediate vertical location as depicted.

Vessel 202 serves as a stripping column and feed water enters the top of vessel 202 at fluid connection 206 and flows downwardly therein in direct counterflow heat exchange with upwardly flowing produced steam as discussed above. The produced steam exits the top of vessel 202 at fluid connection 208. An inlet diverter 210 may be provided on the interior of vessel 202 upon which feed water entering the vessel may imping upon and as a result be downwardly directed. The hot water and steam mixture from the forced recirculation heat exchanger 62 enters at vessel 202 at fluid connection 212 disposed at a vertically lower than connection 208. Sludge collects at the bottom of vessel 202 and is removed therefrom through fluid connection 214.

The intermediate location of fluid connection 206 that connects vessels 202 and 204 together serves as a weir between the two vessels and encourages settling within the first vessel 202 and prevents sludge migration from the first vessel 202 into the second vessel 204. A downwardly extending deflector 216 may be disposed within vessel 202 and across fluid connection 206 to further encourage solid/liquid separation within vessel 202 and prevent sludge or solids migration from downwardly flowing fluid in vessel 202 from passing through connection 206 and into vessel 204. Produced steam that may migrate into vessel 204 is removed at the top thereof through fluid connection 224 and combined with steam from fluid connection 208.

Water from the clean water is removed from vessel 204 at fluid connection 218 for circulation through the forced circulation heat exchanger 62 as discussed above. The vessels 202 and 204 may further include one or more conventional manways 220 for inspecting and cleaning the vessels. Further vessels 202 and 204 may be provided with one or more conventional clean out ports 222, only one is illustrated for purpose of illustrative clarity, for collecting fluid samples from the vessels and for emptying the vessels. One of the clean out ports 222 may be fitted with pH sensor 34. The inclusion and operation of contact vessel 200 in system 10 is readily apparent from the above discussion.

A number of embodiments of the present invention have been described. Nevertheless, it will be understood that various modifications may be made without departing from the spirit and scope of the invention. Accordingly, other embodiments are within the scope of the following claims.

What is claimed is:

1. A continuous thermal process for treatment of raw water including passing the raw water in direct counterflow heat exchange with produced steam to heat the raw water to a temperature at which a substantial portion of dissolved calcium and magnesium ions in the raw water are precipitated as insoluble salts and passing the raw water into a reaction zone for completion of reactions, wherein the improvement comprises adding a strong base to the raw water prior to passing the raw water in direct counterflow heat exchange with the produced steam in amount such that pH of the reaction zone is at least 10.5 as measured by a pH sensor.

2. The process of claim 1, wherein the strong base is NaOH.

3. The process of claim 1, wherein the strong base is added in amount such that the pH of the reaction zone is at least 10.5 as measured by the pH sensor.

4. A continuous thermal process for treating oilfield produced water and generating steam from the same, the process comprising the steps of:
(a) passing raw produced water through a free water knock out thereby forming a feed water;
(b) adding a strong base to the feed water;
(c) introducing the feed water into a contact vessel after buffering;
(d) passing the feed water in direct counter flow heat exchange with a produced steam within the contact vessel to heat the feed water to a temperature at which a substantial portion of dissolved calcium and magnesium ions in the raw water are precipitated as insoluble salts;
(e) passing the feed water into a reaction zone for completion of reactions;
(f) measuring the pH of the feed water in the reaction zone; and
(g) controlling the amount of pH buffer added in step (b) so as to maintain a pH of at least 10.5 is the reaction zone.

5. The process of claim 4, wherein in step (g) the amount of pH buffer addition is controlled so as to maintain a pH of at least 11.0 in the reaction zone.

6. The process of claim 4, wherein in step (b) the strong base is NaOH.

7. The process of claim 4, further comprising the step of:
(h) pre-heating the produced raw water prior to passing through the free water knock out.

8. The process of claim 4, further comprising the steps of:
(h) removing water from the reaction zone and passing it in indirect heat exchange relationship with a heated medium to convert part of the water to produced steam;
(i) passing substantially all of the produced steam in direct heat exchange with the feed water in step (d); and
(j) removing a balance of the produced steam from the contact vessel.

9. The process of claim 4, further comprising the steps of:
(h) removing blow-down sludge from the contact vessel;
(i) passing the blow-down sludge through a separator and forming flash steam, slop oil, and sludge;
(j) condensing the flash steam and recycling the condensed flash steam to the feed water as make-up water prior;
(k) recycling the slop oil to the free water knock out; and
(l) disposing of the sludge.

10. The process of claim 4, wherein the contact vessel includes:
a horizontally disposed settling tank having a series of vertically extending interior baffles that horizontally divided the interior into a clean water compartment and a dirty water compartment;
a stripping column connected to said settling vessel and extending vertically upward therefrom and in fluidic connection with said dirty water compartment;
a sludge boot connected to said settling vessel and extending vertically downward therefrom and in fluidic connection with said dirty water compartment;
a steam outlet at the top of said stripping column and in fluidic communication with the interior of said stripping column;
a feed water inlet at the top of said stripping column at a position vertically bellow said steam outlet and in fluidic communication with the interior of said stripping column;
a water and steam return inlet at the bottom of said stripping column and in fluidic communication with the interior of said stripping column;
a water outlet at said settling vessel and in fluidic communication with the clean water compartment; and
a sludge blow-down at said sludge boot and in fluidic communication with the interior of said sludge boot.

11. The process of claim 4, wherein the contact vessel includes:
first and second vertical vessels fluidically connected together at an intermediate location between their opposed ends;
a steam outlet at the top of said first vertical vessel and in fluidic communication with the interior thereof;
a feed water inlet at the top of said first vertical vessel at a position vertically bellow said steam outlet and in fluidic communication with the interior of said first vertical vessel;
a water and steam return inlet at the bottom of said first vertical vessel and in fluidic communication with the interior thereof;
a sludge blow-down at the bottom of said first vertical vessel and in fluidic communication with the interior thereof;
a water outlet at the bottom of said second vertical vessel and in fluidic communication with the interior thereof; and
a second steam outlet at the top of said second vertical vessel and in fluidic communication with the interior thereof.
